(19) United States
(12) Patent Application Publication
(10) Pub. No.: US 2007/0214240 A1
(43) Pub. Date: Sep. 13, 2007

(54) Method and arrangement for integrating an accelerating client into an application

(75) Inventors: Janne Kalliola, Espoo (FI); Viktor Khashchanskiy, Helsinki (FI)

Correspondence Address: COHEN, PONTANI, LIEBERMAN & PAVANE, 551 FIFTH AVENUE, SUITE 1210, NEW YORK, NY, 10176, US

(73) Assignee: First Hop OY, Helsinki (FI)

(21) Appl. No.: 11/517,930

(22) Filed: Sep. 8, 2006

Related U.S. Application Data
(63) Continuation of application No. PCT/FI05/50077, filed on Mar. 11, 2005.

(30) Foreign Application Priority Data
Mar. 11, 2004 (FI) 20045070

(51) Int. Cl. G06F 15/16

(52) U.S. Cl. 709/219

(57) ABSTRACT

A method provides a content provider with a new way to provide acceleration services and it also provides a user with an easy way to utilize the acceleration services. In more detail, the user can transparently deploy an appropriate accelerating client to his/hers terminal, such as a mobile phone or a laptop. After the deployment the accelerating client is integrated into an application installed in the terminal. The application may be, for example, a browser or a media player. The accelerating client according to the invention is a helper object, a plug-in, or Java applet/application. Especially, the helper object spends less processing capacity of a terminal than the prior art accelerating client implemented as a standalone application.

### CROSS-REFERENCE TO RELATED APPLICATION

This is a continuation of International Application No. PCT/FI2005/050077 filed Mar. 11, 2005.

### BACKGROUND OF THE INVENTION

1 . Field of the Invention

The present invention generally relates to an accelerating client that can be used in a terminal for accelerating transmission between the terminal and a communication network.

2. Description of the Related Art

The known Internet protocols TCP/IP and especially HTTP are best suited for high-speed, fixed networks. In wireless networks, for example in a GPRS (General packet radio services) network, Internet applications may operate poorly because of low transmission rates. The Internet traffic and/or performance of Internet applications can be improved by software termed an accelerating system. Also the term performance enhancing proxy has been used in prior art. An accelerating system includes at least an accelerating server placed in a communication network and possible accelerating clients placed in end-users' terminals. There are basically two kinds of solutions: a client-server solution or a server solution. The client-server solution includes the accelerating clients and the accelerating server. The server solution includes only the accelerating server. This patent application concerns the client-server solution.

Packing is an acceleration technique, or an acceleration action, which is most widely used. More information about traffic acceleration and different acceleration actions can be found in the applicant's former patent application, PCT/FI02/00703. In addition to these acceleration actions, there are many other known acceleration actions.

MIME (Multipurpose Internet Mail Extensions), as well as Java techniques, are used in certain embodiments of the invention, thus we will shortly discuss them in the following.

MIME is a standard for describing different types of information. MIME was originally used to specify how a different type of information is encoded into text. Encoding made it possible to send the information as an email via the Internet to a terminal. The sent information was decoded at the terminal in accordance with its MIME type.

The original MIME types were defined in RFC 1341 in 1992. After that the IETF (Internet Engineering Task Force) has defined other RFC's related to MIME. A single MIME type is a certain character string, for example, “text/html” or “application/zip”. The MIME types can be divided into categories, such as: Application, Audio, Image, Message, Text, Video, etc.

The terminal that receives MIME encoded files needs appropriate applications in order to handle said files. Let us assume that one of the files is a Word document and another file is a PDF image file. Then two different applications are needed: Word or a corresponding word processor capable of reading the Word file, and Adobe Acrobat or corresponding application capable of reading the PDF file. Usually, the conversions from the MIME encoded files into to the Word file and the PDF file are performed by the email application. It is also possible to store the MIME encoded files on a disk.

MIME can be utilized in other types of communication, too. When a MIME type discloses a type of the resource obtainable from a certain WWW server, a browser can start an application that is able to handle the resource. The MIME type may be placed in a mark-up language page, such as an HTML page. Then the browser obtains the MIME type from the mark-up language page. Alternatively, the MIME type can be placed in a header of a packet which is transmitted from a server to a terminal. In that case the terminal obtains the MIME type from data of the transmission.

The Java Runtime Environment (JRE) provides the libraries, the Java Virtual Machine, and other components to run applets and applications written in the Java programming language. These applets and applications, and other possible Java software are termed here “Java code”. In addition, two deployment software are part of the JRE: Java Plug-in, which enables applets to run in browsers; and Java Web Start which deploys, i.e. downloads and installs, standalone applications over a communication network.

Java Plug-in requires a one-time download and installation that takes a number of minutes, depending on the network and the terminal in which the Java Plug-in software is installed. After the installation Java Plug-in can execute Java applets. Java Plug-in is also able to store Java applets in cache memory and load them from the cache memory. This reduces the need to download the same Java applets again from the network to the terminal.

When using the Java Web Start software Java applications can be deployed with a single click over the network. Java Web Start ensures that the most current version of the application will be deployed, as well as the correct version of the Java Runtime Environment (JRE).

FIG. 1 shows an accelerating client and an accelerating server. Let us assume that a user explores Web pages using a browser 101 installed in a terminal 102. The Web pages that interest the user are located in a server 103. This server is termed “a content server” to distinguish it from an accelerating server 104. The content server sends content of the Web pages, for example, using HTTP to the terminal 102. The HTTP transmission is transmitted via the accelerating server 104 and a communication network 105 to the terminal 102. An accelerating client 106 installed in the terminal 102 accelerates said transmission, together with the accelerating server 104. The user can detect a result of the acceleration, because the Web pages are rapidly received at the terminal 102 and shown on its display 107.

A transmission to be accelerated could also be directed from the terminal 102 to the server 103. In general, traffic acceleration applies to any kind of transmission. This transmission includes, for example, Web pages, images, sounds, etc.

FIG. 2 illustrates how an accelerating client is implemented in the prior art. A browser 201, as well as an accelerating client 202, is a standalone application which operates under the control of an operating system 203. The browser 201, the accelerating server, and the operating system 203 are installed in a terminal. The terminal is omitted from FIG. 2. Thus, in the prior art the accelerating client 202 is a standalone application. A user can start the said standalone application through the operating system 203, for example, by clicking an icon of the accelerating client 202. Alternatively, the accelerating client 202, i.e. the standalone application, can be automatically started when the operating system 203 is started.

A terminal may have a quite inefficient processor and a low-capacity memory. The processing capacity of the terminal is completely in use when it executes an operating system, an accelerating client, and e.g. a browser. The accelerating client, which operates well in a laptop, does not necessarily operate well in a mobile phone. In addition to the laptop and mobile phone, traffic acceleration concerns other types of terminals, too.

A first drawback of the prior accelerating client is that it wastes the processing capacity, memory, and/or disk resources of a terminal.

A second drawback is that users may have lack of information about obtaining acceleration services. In the prior art a user should download an accelerating client from a service provider's Web site to his/her terminal. Then the user must know the Internet address of the service provider's Web site. In addition, the user must know which version of the accelerating client to download.

A third drawback is that content providers have a lack of means for providing acceleration services. By means of these services users could use HTML pages and other type of content more fluently.

A fourth drawback is poor usability of an accelerating client. In the prior art a user must explicitly start and close the accelerating client. The user may have a lack of skills for using the prior art acceleration client. In more detail, the user sometimes doesn't know whether he/she should associate the accelerating client to an application. Or the user doesn't know when to start or close the accelerating client.

### SUMMARY OF THE INVENTION

The invention solves at least partly the above-mentioned drawbacks. It provides a content provider with a new way to provide acceleration services and it provides a user with an easy way to utilize the acceleration services. In more detail, the user can transparently deploy an appropriate version of an accelerating client to his/hers terminal so that the accelerating client is integrated into an application installed in the terminal. The application may be, for example, a browser, a media player, a dial-up application, a mail application, a news reader, an instant messaging application, or a client application of a VPN (Virtual Private Network).

When the accelerating client is integrated into the application, it is usable only with the application installed in the terminal. The accelerating client according to the invention is a helper object, a plug-in, Java applet, or Java application. Especially, the said helper object spends less processing capacity of a terminal than the prior art accelerating client implemented as a standalone application.

The invention comprises a method, an accelerating client, and an application into which the accelerating client is integrated.

The method is intended for accelerating transmission between a terminal and a communication network. The method includes at least the steps of:
initiating the transmission by using an application installed in the terminal,
receiving the transmission in the accelerating client installed in the terminal, wherein the accelerating client is one of the following objects:
a helper object which is started at the terminal in accordance with configuration settings of said application,
a plug-in which is started at the terminal when said application obtains a MIME (Multipurpose Internet Mail Extensions) type mapped to a said plug-in,
Java code which is downloaded to the terminal and started in the Java Runtime Environment when the transmission is initiated from a mark-up language page containing a URI (Uniform Resource Identifier) of said Java code,
and performing by means of the accelerating client at least one acceleration action directed to the transmission.

In addition to the above steps, the method includes optional steps by which the accelerating client can be deployed to the terminal and by which a user interface can be created on a display of the terminal.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is described more closely with reference to the accompanying drawings, in which

FIG. 1 shows an accelerating client and an accelerating server,

FIG. 2 illustrates how an accelerating client is implemented in the prior art,

FIG. 3 illustrates how the accelerating client according to the invention is implemented,

FIG. 4 shows the main steps of the method,

FIG. 5 shows optional steps of the method,

FIG. 6 shows an accelerating client and an application according to the invention.

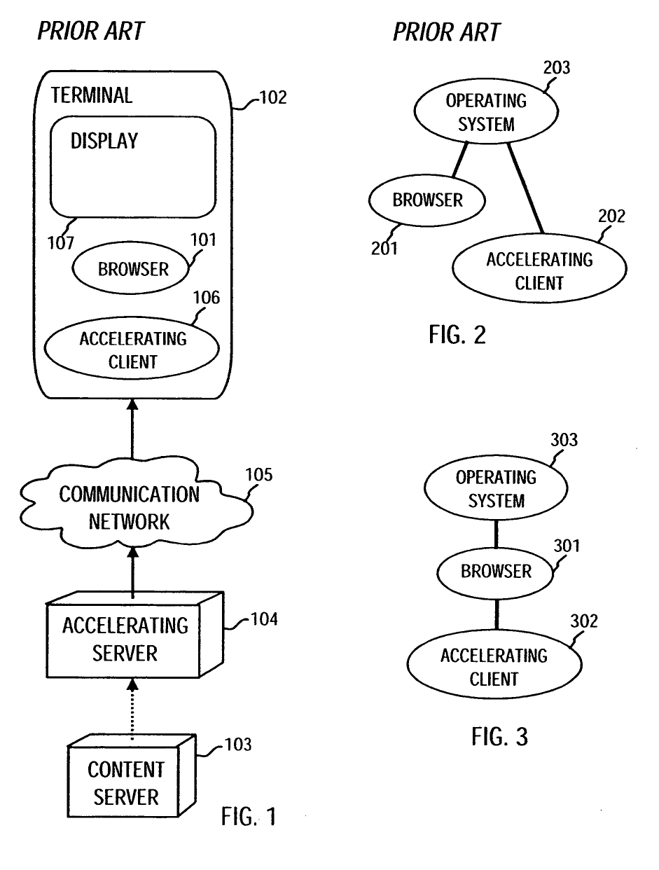

### DETAILED DESCRIPTION OF THE PRESENTLY PREFERRED EMBODIMENTS

The invention can be utilized in client-server solutions, wherein an accelerating client accelerates transmission, together with an accelerating server. The accelerated transmission may be directed from a communication network to the terminal, or vice versa.

FIG. 3 illustrates how an accelerating client is implemented in the invention. This accelerating client can be compared to the accelerating client shown in FIG. 2. A browser 301 is a standalone application; the accelerating client 302 is not. The browser operates under the control of an operating system 303 and the accelerating client 302 operates under the control of the browser 301. If the accelerating client 302 is a helper object, configuration settings of the browser 301 determine that helper object is started when the browser is started. Then the accelerating client/helper object is automatically closed when the browser is closed. Also, if the accelerating client 302 is a plug-in, it is started and closed under the control of the browser 301. The helper object, as well as the plug-in, is preferably downloaded once to a terminal and installed in the terminal. In the third alternative the accelerating client 302 is Java code. Then the accelerating client/Java code must be downloaded each time to the terminal when a user needs acceleration services.

Thus, the accelerating client 301 is one of the following objects: a helper object, a plug-in, or Java code. In the all alternatives the accelerating client 302 is integrated into the browser 301 so that it can be used only with the browser 301. This in one detail that differs the accelerating client 302 from the prior art accelerating client 202. The integration essentially saves the processing capacity of a terminal, especially if the terminal is a mobile phone and the acceleration client 302 is implemented as a helper object. Instead of the browser 301 the accelerating client 302 can also be integrated into other types of applications.

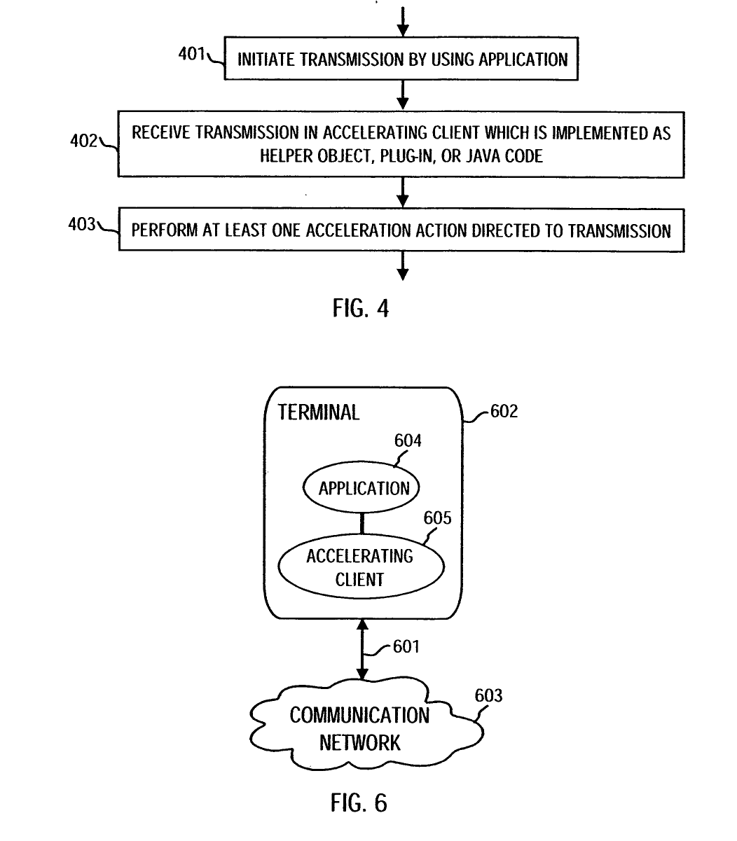

FIG. 4 shows the main steps of the method intended for accelerating transmission between a communication network and a terminal. The method includes the step of initiating 401 the transmission by using an application installed in the terminal. Let us assume that a user clicks a hyper link of a Web page. The clicking of the hyper link results in a HTTP request, which is transmitted from the user's terminal via a communication network to a server containing the Web page. Then as a response to the HTTP request the server begins a transmission via the communication network to the terminal. This is just one example of a transmission to be accelerated. In addition to the browser and the HTTP, there are many other applications and protocols that can be used within the method. The method includes the step of receiving 402 the transmission in an accelerating client installed in the terminal, wherein the accelerating client is one of the following objects: 1) a helper object which is started at the terminal in accordance with configuration settings of said application, 2) a plug-in which is started at the terminal when said application obtains a MIME type related to the transmission and the MIME type is mapped to said plug-in, or 3) Java code which is downloaded to the terminal and started in the Java Runtime Environment when the transmission is initiated from a mark-up language page containing a URI (Uniform Resource Identifier) of said Java code. Finally, the method includes the step of performing 403 by means of the accelerating client 1), 2) or 3) at least one acceleration action directed to the transmission.

In addition to the main steps shown in FIG. 4 the method may also include one or more optional steps.

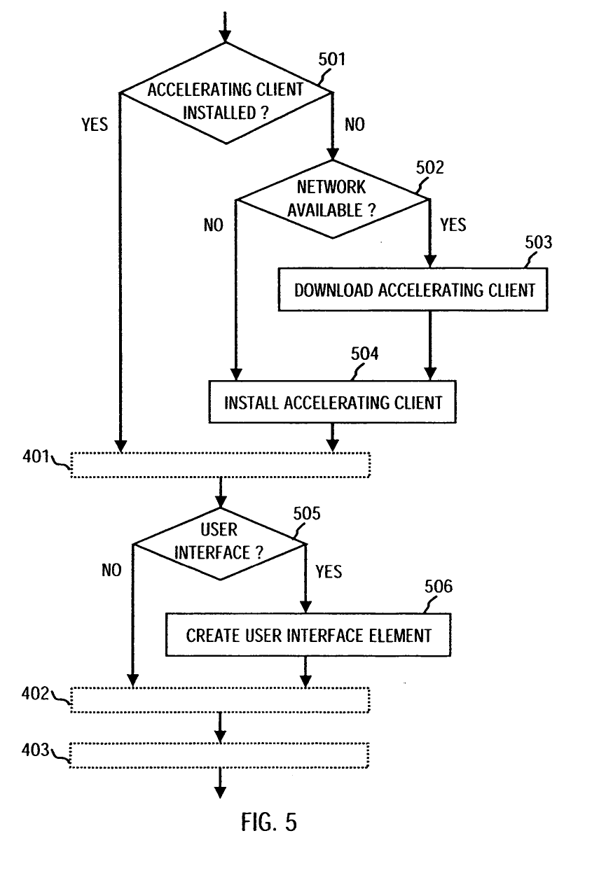

FIG. 5 shows the optional steps of the method. If the accelerating client is not yet installed 501 in the terminal, before step 401 is performed the step of installing 504 the accelerating client in the terminal must be performed. The accelerating client can be installed to the terminal from a disk when the terminal is e.g. a laptop. Alternatively, the accelerating client can be installed to the terminal via a wire link or a wireless link. USB and Bluetooth are examples of links which the terminal may support. However, when the communication network is usable 502, it is preferably utilized in the installing 504. Then the method includes the step of downloading 503 the accelerating client to the terminal. In more detail, the accelerating client is downloaded via the communication network from a certain URL (Uniform Resource Locator) disclosed in a mark-up language page. A browser or another application, which a user is using, detects the URL placed on the mark-up language page interesting the user. The URL refers to such a version of an accelerating client that is intended to accelerate the transmission initiated from the said mark-up language page. Therefore, by means of the steps of 503 and 504 the user can transparently deploy the appropriate version of the accelerating client to his/hers terminal while he/she is browsing the mark-up language page. If the accelerating client is equipped with a user interface 505, the method includes the step of creating 506 a user interface element on a display of the terminal as response to starting 402 the accelerating client. The user interface element may be, for example, a button, a toolbar, a menu, or a window.

The accelerating client can be implemented so that it is executed in the terminal as long as the application is executed in the terminal. It is also possible to implement the accelerating client so that the user can activate and deactivate the accelerating client through the user interface element created in step 506. In other words, the user can start the execution of the accelerating client and stop its execution.

Generally speaking, the user interface enables a user to control use of the accelerating client. In addition to the above-mentioned option to activate and deactivate the accelerating client, the user may have an option of removing the accelerating client from the terminal. The user may also have an option to input through the user interface element at least one parameter for the accelerating client. The parameter(s) may concern, for example, a set of acceleration actions, i.e. which acceleration actions are performed and which are not.

Thus, the accelerating client may receive at least one parameter from a user. In addition to the user input(s), there are other possible sources of parameter(s).

Parameter(s) may be from a mark-up language page, such as a HTML page. The HTML page may be either static or generated ad hoc. For example, a content server or an accelerating server may generate the HTML page on the basis of an IP address of the user, authentication data of the user, or on the basis of an MSISDN or an IMSI number of the terminal. In addition or alternatively, the parameter(s) from the mark-up language page may contain, for example, an IP address of the accelerating server, traffic acceleration settings, or TCP forwarding settings. The accelerating client may receive the parameter(s) directly from the mark-up language page, or via a browser or a corresponding application that starts the accelerating client.

Parameter(s) may be from the transmission to be accelerated. Then the acceleration client obtains parameter(s) from a header of a packet belonging to the transmission. The header may be a general-purpose header or a specific header intended for this purpose.

Parameter(s) may be from the accelerating server that places the parameter(s) in a header of a packet belonging to the transmission.

Parameter(s) may be from system files of the terminal in which the application as well as the accelerating client are installed. It possible that the accelerating client reads, for example, system files of Windows in order to obtain parameter(s).

The above parameter(s) adjust the accelerating client according to the invention, i.e. the operation of the accelerating client. The parameter(s) may be stored either permanently or temporarily in a memory of the terminal, for example, in the configuration settings of the application.

The accelerating client is preferably implemented so that a user needs to input as few parameter(s) as possible. Then the accelerating client obtains the parameter(s) from the other above-mentioned sources and is able to determine in which way it must operate in the terminal. For example, instead of asking the user information about a communication link of the terminal, the accelerating client could extract this information from the system files or from the accelerating server.

FIG. 6 shows an accelerating client and an application according to the invention. In this example traffic acceleration relates to a transmission 601 between a terminal 602 and a communication network 603, wherein the transmission is initiated by using an application 604 installed in the terminal. The transmission 601 is directed from the terminal 602 to the communication network 603, or vice versa. An accelerating client 605, which is also installed in the terminal 602, is adapted to receive transmission 601 initiated by the application 604, wherein the accelerating client 605 is one of the following objects: 1) a helper object, 2) a plug-in, 3) Java code, and it is adapted to perform at least one acceleration action directed to the received transmission 601. The accelerating client 605 may be further adapted to create a user interface element on a display of the terminal 602 as a response to starting the accelerating client.

The starting of the accelerating client 605 varies in all the above implementations 1), 2), and 3).

If the accelerating client 605 is implemented as a helper object, it is adapted to get started at the terminal 602 in accordance with configuration settings of the application 605 when the application 605 is started.

If the accelerating client 605 is implemented as a plug-in, it is adapted to get started at the terminal 602 when the application 602 obtains a certain MIME (Multipurpose Internet Mail Extensions) type related to the transmission 601 and finds the said MIME type in a list of installed plug-ins in which each MIME type is mapped to a certain plug-in. The MIME type is preferably a new, currently undefined MIME type, such as
application/x_fh_accelerating_client

The MIME type indicates for the application 602 that it should start the plug-in/accelerating client. If the MIME type is not found from the list of installed plug-ins, the plug-in/accelerating client is preferably downloaded via the communication network 603 and installed in the terminal 602 after which the MIME type is added to the list.

If the accelerating client 605 is implemented as a Java code, the accelerating client is adapted to get started at the terminal 602 in the Java Runtime Environment, if the application 604 draws a conclusion that a URL included in the mark-up language page, from which the application initiated the transmission 601, points to the JAVA code/accelerating client. The said conclusion may be based on, for example, one of the following cases:
the page contains a character string “<applet”,
the page contains a MIME type “application/java”,
the URL is obtained from the page that contains a character string “.class”,
the URL is obtained from a page that contains the character string “.jar”

If the conclusion is that the URL included in the mark-up language page points to the JAVA code, said Java code is downloaded to the terminal 602 to be started in the Java Runtime Environment. The term “Java code” refers to Java software which may be a Java applet or a Java application, but which may also include the Java Runtime Environment or a part of it. The Java applet is usually downloaded in the form of a JAR (Java Archive) file. The JAR file contains all class files of the Java applet and some extra information.

In addition to the method and the accelerating client, the invention comprises the application into which the accelerating client can be integrated.

FIG. 6 also shows an application 604 according to the invention. The application 604 is able to initiate at least one transmission between the communication network 603 and the terminal 602. The application comprises the accelerating client 605 which is one of the following objects: 1) a helper object, 2) a plug-in, or 3) a Java code. The application 604 is adapted to, by means of said accelerating client 605, perform at least one acceleration action directed to the transmission 601. The application may be further adapted to download the accelerating client 605 to the terminal 602 from a URL (Uniform Resource Locator) disclosed in a mark-up language page before the transmission 601 is initiated from said mark-up language page. The said URL may refer to an accelerating server intended to accelerate the transmission 601 together with the accelerating client. The application may be further adapted to install the accelerating client 605 that is either said helper object or said plug-in in the terminal 602.

As mentioned many times in the above text, the transmission 601 is usually initiated when the application 604 handles a mark-up language in accordance with a certain protocol. For example, the transmission may be started when browsing the mark-up language page. In the following we show three examples of the mark-up language page:

### EXAMPLE 1

```
<object width=“698” height=“401”>
  <param name=“movie” value=“movie.swf”>
  <param name=“quality” value=“high”>
  <param name=“LOOP” value=“false”>
  <param name=“BGCOLOR” value=“#FFFFFF”>
  <embed src=“http://www.firsthop.com/movie.swf”
    width=“698” height=“401” loop=“false” quality=“high”
    pluginspage=“http://www.macromedia.com/go/getflashplayer”
    type=“application/x-shockwave-flash”
    bgcolor=“#FFFFFF”></embed>
</object>
```

In Example 1 the code line starting with “<embed src” discloses the content of the page, or in more detail, the content of an element which is placed on the page. The element is composed of the code lines between the tag “<object width” and the tag “</object>”. The code line starting with “pluginspage” discloses from where the plug-ins can be searched. The code line starting with “type” discloses the MIME type “x-shockwave-flash”.

### EXAMPLE 2

```
<applet code=“http://www.firsthop.com/SimpleDrawing3.class”
  width=150 height=150>
    <param name=“foo” value=“bar”>
</applet>
```

In Example 2 the tag “<applet code” discloses that the element of the mark-up language page contains a Java applet.

### EXAMPLE 3

```
<object codetype=“application/java”
  classid=“java:MyApplet.class”
  width=“300” height=“100”>
    <param name=“background-color” value=“#ffffff” />
    <param name=“foreground-color” value=“#000000” />
</object>
```

In Example 3 the code line starting with the tag “<object codetype” includes a MIME type. This MIME type discloses for the application that it should start the Java Runtime Environment.

In addition to the examples and the embodiments of the invention explained above, there are many other possible examples and embodiments which are obvious for a person skilled in the art and should considered to be included in the scope of the following patent claims.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A method for accelerating transmission between a communication network and a terminal, wherein the method comprises the steps of
initiating the transmission from a mark-up language page by using an application installed in the terminal, said mark-up language page disclosing a URL (Uniform Resource Locator) of an accelerating client,
receiving the transmission in the accelerating client previously downloaded from the URL and installed in the terminal, the accelerating client being one of the following objects:
a helper object which is started at the terminal in accordance with configuration settings of said application,
a plug-in which is started at the terminal when said application obtains a MIME (Multipurpose Internet Mail Extensions) type related to the transmission and the MIME type is mapped to said plug-in,
Java code which is downloaded to the terminal and started in the Java Runtime Environment when the transmission is initiated from the mark-up language page containing a URI (Uniform Resource Identifier) of said Java code,
and performing by means of the accelerating client at least one acceleration action directed to the transmission.

2. The method as in claim 1, wherein the application is one of the following applications:
a browser, a media player, a dial-up application, a mail application, a news reader, an instant messaging application, a client application of a VPN (Virtual Private Network).

3. The method as in claim 1, wherein the accelerating client being missing from the terminal, the method includes a further step of downloading the accelerating client to the terminal from the URL disclosed in the mark-up language page before the transmission is initiated from said mark-up language page.

4. The method as in claim 3, wherein the URL refers to an accelerating server intended to accelerate the transmission together with the accelerating client.

5. The method as in claim 1, wherein the accelerating client being either the helper object or the plug-in which is missing from the terminal, the method includes the further step of installing the accelerating client in the terminal.

6. The method as in claim 1, wherein the method comprises a further step of creating a user interface element on a display of the terminal as response to starting the accelerating client.

7. The method as in claim 6, wherein the user interface element is one of the following elements: a button, a toolbar, a menu, a window.

8. An accelerating client for accelerating transmission between a communication network and a terminal, wherein the accelerating client installed in the terminal is adapted to
receive transmission initiated from a mark-up language page by an application installed in the terminal, said mark-up language page disclosing a URL (Uniform Resource Locator) from which the accelerating client is downloadable to the terminal, the accelerating client being one of the following objects:
a helper object which is started at the terminal in accordance with configuration settings of said application,
a plug-in which is started at the terminal when said application obtains a MIME (Multipurpose Internet Mail Extensions) type related to the transmission and the MIME type is mapped to said plug-in,
Java code which is downloaded to the terminal and started in the Java Runtime Environment when the transmission is initiated from the mark-up language page containing a URI (Uniform Resource Identifier) of said Java code,
and perform at least one acceleration action directed to the transmission.

9. The accelerating client as in claim 8, wherein the application is one of the following applications: a browser, a media player, a dial-up application, a mail application, a news reader, an instant messaging application, a client application of a VPN (Virtual Private Network).

10. The accelerating client as in claim 8, wherein the accelerating client is adapted to create a user interface element on a display of the terminal as response to starting the accelerating client.

11. The accelerating client as in claim 10, wherein the user interface element is one of the following elements: a button, a toolbar, a menu, a window.

12. An application that is able to initiate from a mark-up language page transmission between a communication network and a terminal, wherein the application comprises an accelerating client that is disclosed in a URL (Uniform Resource Locator) included in said mark-up language page, the accelerating client being one of the following objects:
a helper object which is started at the terminal in accordance with configuration settings of said application,
a plug-in which is started at the terminal when said application obtains a MIME (Multipurpose Internet Mail Extensions) type related to the transmission and the MIME type is mapped to said plug-in,
Java code which is downloaded to the terminal and started in the Java Runtime Environment when the transmission is initiated from the mark-up language page containing a URI (Uniform Resource Identifier) of said Java code;
the application being adapted to
download the accelerating client to the terminal from the URL before the transmission is initiated from said mark-up language page, and by means of said accelerating client,
perform at least one acceleration action directed to the transmission initiated by the application.

13. The application as in claim 12, wherein the application is a browser, a media player, a dial-up application, a mail application, a news reader, an instant messaging application, or a client application of a VPN (Virtual Private Network).

14. The application as in claim 12, wherein the URL refers to an accelerating server intended to accelerate the transmission together with the accelerating client.

15. The application as in claim 12, wherein the application is adapted to install the accelerating client that is either said helper object or said plug-in in the terminal.
